(19) United States
(12) Patent Application Publication
(10) Pub. No.: US 2002/0022446 A1
(43) Pub. Date: Feb. 21, 2002

(54) Fish loading device for a fish processing machine

(76) Inventors: Richard P. Scherch, Fort Myers, FL (US); Ralph A. Miller, Naples, FL (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/837,616

(22) Filed: Apr. 18, 2001

Related U.S. Application Data
(60) Provisional application No. 60/198,892, filed on Apr. 21, 2000.

(51) Int. Cl. A22C 18/00; A22C 21/00; A22C 25/06

(52) U.S. Cl. 452/194

(57) ABSTRACT

A fish loading device for loading fish onto a fish processing machine is disclosed. The fish loading device comprises a pair of substantially parallel plates located on either side of a transport track that is used to carry the fish through the various processing stations in the processing machine. The fish is carried along the transport track on a transport saddle. The plates are spaced apart sufficiently to allow the transport saddle to pass between them. The fish is placed onto the plates, which are configured so as to hold the fish in a fixed position relative to the transport saddle. When the saddle passes through the region, it engages the body of the fish and carries it through the various processing stations. The fish loading device allows for consistent loading of the fish onto the saddle, resulting in increased efficiency, productivity and yield.

### RELATED APPLICATION

This application claims the benefit of priority under 35 U.S.C. § 119(e) of U.S. Provisional Application No. 60/198,892, filed Apr. 21, 2000, the entirety of which is hereby incorporated by reference.

### BACKGROUND OF THE INVENTION

1. Field of the Invention

The invention relates to a processing machine for fish. More particularly, the invention relates to a loading device for loading fish onto a transport saddle of an automated fish processing machine.

2. Description of the Related Art

Automated fish processing machines often use a conveyer-type system to produce a boneless, skinless filet from fish such as whitefish or catfish. The conveyor moves the fish through various sections of the processing machine. For example, one section of the processing machine separates the two halves of the gutted fish, after which another section cuts the bone away. The boneless filets are then processed through a section for removing the skin, resulting in a boneless, skinless filet of fish ready for packaging. One such conveyer-type fish processing machine is described in U.S. patent application Ser. No. 09/186,040, filed Oct. 21, 1998, the entirety of which is hereby incorporated by reference.

One variation of the conveyer-type processing machine provides a saddle for transporting the fish through the various sections of the processing machine. A fish is manually placed on the transport saddle by a worker in an orientation predetermined to cooperate with the filleting, boning and skinning sections of the processing machine. For example, a fish that has already been gutted and headed is placed on the saddle with the tail leading into the processing sections. The machine is then configured to perform the various processing steps as the fish passes through. The arrangement of the cutting tools is based, for example, on the size or type of fish being processed.

One disadvantage of this system is the variation in position that naturally occurs when the fish is placed on the transport saddle by a human. Although the worker is able to consistently place the fish in the proper orientation (e.g., tail leading), a human is unable to precisely place each fish in the exact same position relative to the saddle. The processing tools used in the machine must then be adjusted to account for this imprecision. To accommodate the variations in position, the cutting tools may be placed further than necessary from the center of the fish, for example. Thus, much of the fish meat may be wasted with the bone, resulting in a very inefficient processing system.

Additionally, the saddle typically does not stop at the loading station for the worker to place the fish on the saddle. Instead, the worker must place the gutted fish on the saddle when the empty moving saddle passes through his station. Placing the fish on a moving saddle often results in additional variances in the placement of the fish. The fish body can move to one side, or from side to side, or even fall off the saddle completely. Further, the worker may occasionally have to wait for the saddle to reach his station while holding the fish, wasting his time and energy.

Thus, there is a need for an improved system for processing fish to produce boneless, skinless filets more efficiently, more profitably, and with increased yield.

### SUMMARY OF THE INVENTION

Described herein is a device that facilitates the loading of a fish onto a saddle-type processing machine and that provides a proper and consistent loading of the fish onto a transport saddle in a correct and consistent position.

In one embodiment of the invention there is provided a fish loading device for use in a fish processing machine, comprising a pair of substantially parallel plates mounted on either side of a transport track. The transport track is used to carry fish through the fish processing machine. The plates are spaced apart sufficiently to allow a transport saddle to pass between them, and the plates are adapted to hold a fish in a fixed position and allow the transport saddle to engage and remove the fish from the plates as it passes. The plates are preferably formed of metal, such as stainless steel, and are preferably substantially flat. The plates are preferably removably mounted to a support rail, using an L-shaped bracket, such that the vertical position of the plates relative to the transport track is adjustable. A vertically elongated through-hole is preferably formed in the plates to enable the adjustment of the vertical height of the plates. Each plate is substantially rectangular in shape, and has a back end that tapers toward a front end of the plate. A rounded front top edge, extending slightly forward of a bottom front edge, prevents snagging of the fish as is it removed from the plate.

In a preferred embodiment, the fish loading device further comprises a pair of guide elements located on either side of the transport track. The guide elements are located downstream of the plates, and are angled outward, preferably at an angle of about 50 degrees. At least a portion of the plates is located between the guide elements, and the guide elements are spaced apart sufficiently to allow the transport saddle to pass between them.

The guide elements are preferably substantially flat and made of metal. They are preferably mounted on a table top that extends horizontally on either side of the transport track, using an L-shaped bracket. If desired, the guide elements are removably mounted.

In yet another embodiment of the invention, there is provided a fish processing machine, comprising a loading area, a transport track formed along a longitudinal axis, the track passing through the loading area, a transport saddle which travels along the transport track, and a loading device comprising a pair of substantially parallel plates mounted on either side of the transport track. The plates are spaced apart sufficiently to allow the transport saddle to pass between them, and are adapted to hold a fish in a fixed position and allow the transport saddle to engage and remove the fish from the plates as it passes between them.

In a preferred embodiment, the machine further comprises a pair of guide elements located on either side of the transport track, located downstream of the plates. The guide elements are angled outward, and at least a portion of the plates is located between the guide elements. The guide elements are spaced apart sufficiently to allow the transport saddle to pass between them.

Yet another embodiment of the invention provides a method for loading a fish onto an automated fish processing machine having at least one processing station. The body of a fish is place onto a fish loading device comprising a pair of plates mounted substantially parallel on either side of a transport track. The device securely holds the body of the fish in a fixed position and a transport saddle is moved along the transport track and between the plates to engage the body of the fish and carry it along the transport track and through the processing station.

The embodiments of the invention described herein allow for consistent loading of the fish onto the transport saddle, resulting in increased efficiency, productivity and yield.

### BRIEF DESCRIPTION OF THE DRAWINGS

FIG. 1 is a perspective view of a fish processing machine which incorporates a first embodiment of a fish loading device in the loading section of the processing machine.

FIG. 2 is a top view of the loading section of the processing machine, showing the first embodiment of the fish loading device mounted thereon.

FIG. 3 is a front view of one embodiment of the connection of the fish loading device to an L-bracket.

FIG. 4 is a side view of the first embodiment of the fish loading device.

FIG. 5 is a perspective view of the loading section of a fish processing machine having a second embodiment of a fish-loading device mounted there on.

FIG. 6 is a side view of the second embodiment of the fish loading device.

FIG. 7 is a perspective view of the second embodiment of the fish loading device having the body of a fish placed thereon.

### DETAILED DESCRIPTION OF THE PREFERRED EMBODIMENTS

The fish loading device described herein is preferably used in conjunction with an automated fish processing machine. For example, the fish processing machine can be a fish filleting machine, such as the BAADER 184 whitefish filleting machine available from Baader Food Processing Machinery, Fort Myers, Fla.

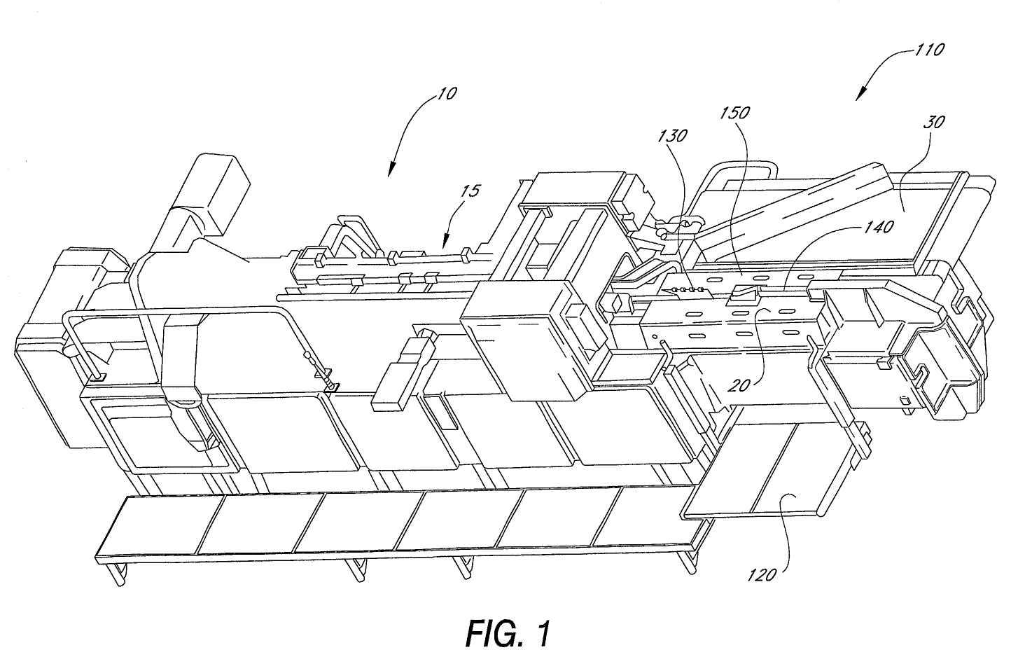

FIG. 1 is an illustration of one such fish processing machine 10. Gutted fish, either headed or with the head still on (not shown) are provided in a supply bin 30 located in the fish loading area 110. A platform 120 is provided for a worker to stand on. The height of the platform 120 can be adjusted to a level that is most comfortable for each individual worker.

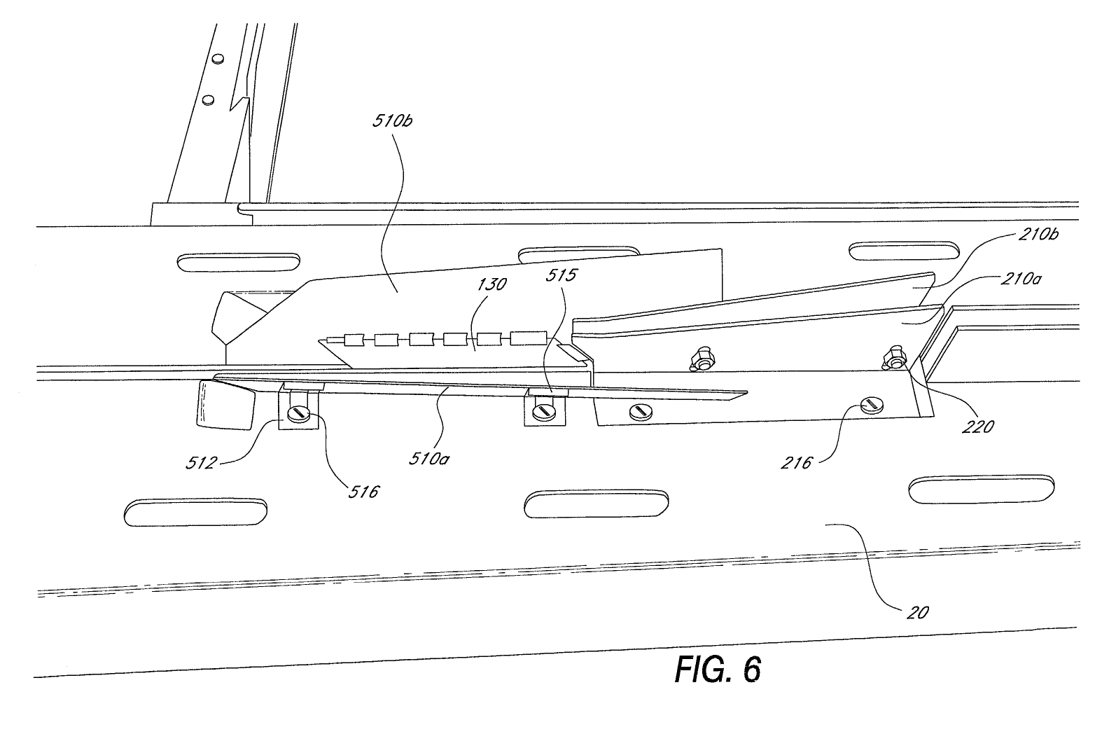

A transport saddle 130 moves along a transport track 140 that is positioned substantially throughout the length of the processing machine 10, including the fish loading area 110. As illustrated in FIG. 1, the transport saddle 130 moves from the fish loading area 110 on the right to the processing stations 15 on the left. The transport saddle 130 is coupled to a conveyer, such as a drive belt or a drive chain, to provide movement through the various sections of the fish processing machine 10. Preferably, the transport saddle 130 is provided with a plurality of teeth 129 (as is best seen in FIG. 6) to engage the fish during transport. Thus, the fish is held in a stable position while the various processing operations are performed. Additional embodiments of the transport saddle 130 are described in detail in U.S. patent application Ser. No. 09/186,040, which is hereby incorporated by reference in its entirety.

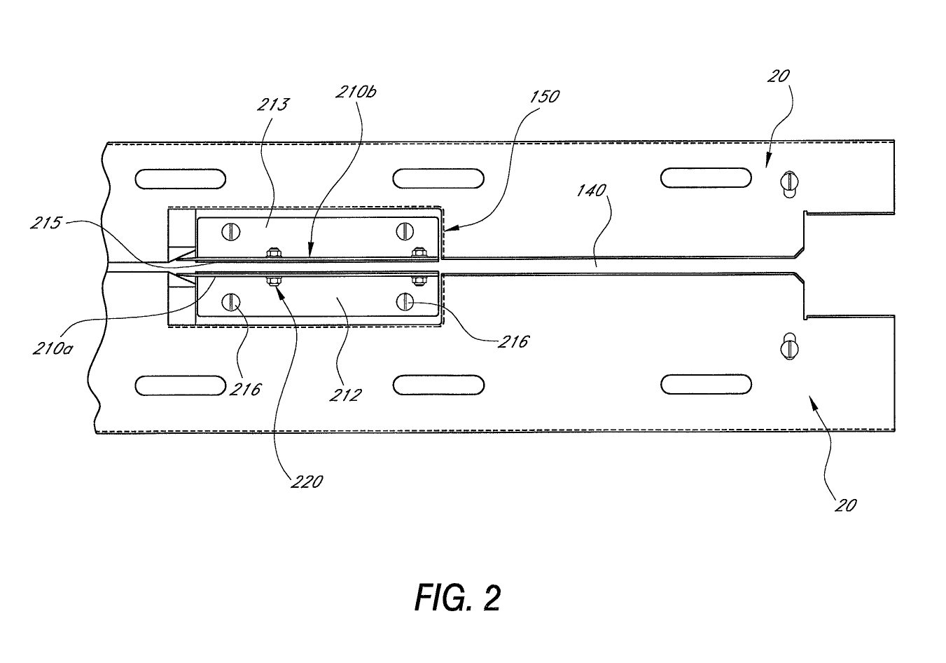

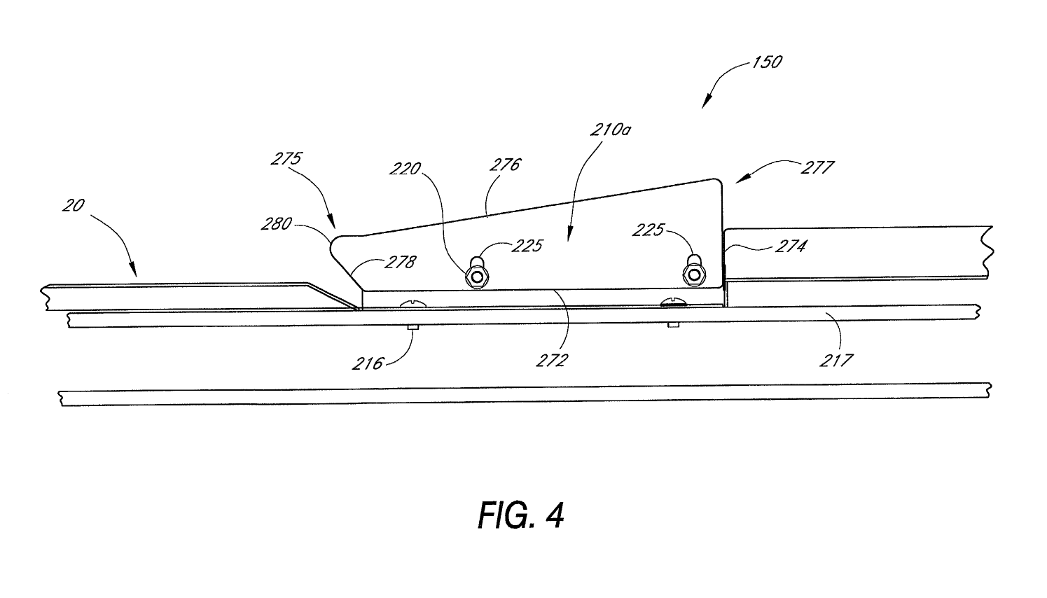

In accordance with one embodiment of the invention, a fish loading device 150 is provided in the fish loading area 110. One embodiment of the fish loading device 150 is shown in FIGS. 2-4. FIG. 2 is a top view of the fish loading device 150 installed in the loading area 110 on the fish processing machine 10. Typically, the fish processing machine 10 includes a flat area or table top 20 which is mounted on a support rail 217 (best seen in FIG. 4). The fish loading device 150 is mounted to the support rail 217 beneath the table top 20 in the fish loading area 110. The vertical level of the table top 20 is preferably adjustable relative to the level of the transport track 140 and the transport saddle 130 to accommodate fish of varying sizes.

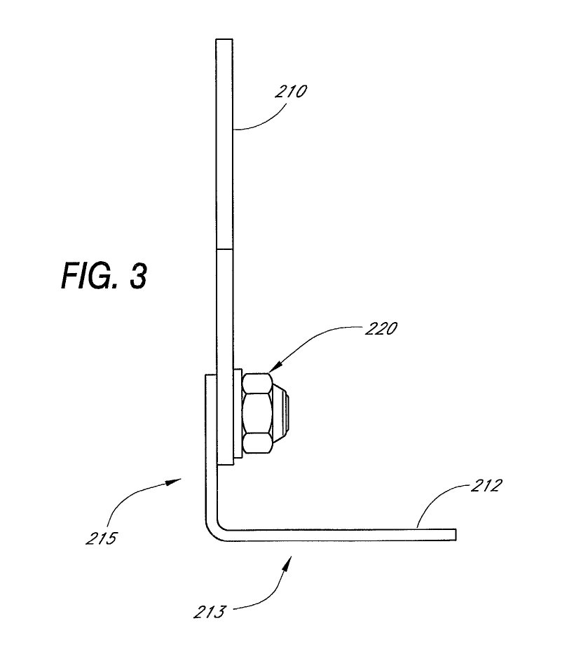

The fish-loading device 150 comprises two guides or support plates 210a,b, positioned substantially parallel to one another, one on each side of the transport track 140. The plates 210a,b are preferably identical and made of metal such as stainless steel or aluminum. As can best be seen in FIG. 3, the plates 210a,b are preferably flat and are mounted substantially vertically onto the support rail 217 via an L-bracket 212. The mounting is preferably removable and adjustable, although it can be permanent, if desired. In either case, the spacing between the two plates 210a,b is sufficient to allow the transport saddle 130 to pass between them along the transport track 140.

As shown in FIG. 3, the L-bracket 212 has a horizontal portion 213 and a vertical portion 215. The horizontal portion 213 of the L-bracket 212 is preferably provided with two through-holes. Screws 216 are preferably used to secure the L-bracket 212 to the support rail 217, although other removable fastening means can also be used. The vertical portion 215 of the L-bracket 212 is secured to the plates 210a,b using bolts 220 or similar removable fasteners. Alternatively, the L-bracket can be permanently mounted to the support rail 217, to the plate 210, or to both. FIG. 3 illustrates the engagement of the L-bracket 212 to the plate 210 using a bolt 220.

Each of the plates 210a,b is also preferably provided with through-holes that match the through-holes in the vertical portion 215 of the L-bracket 212 or other mounting surface. The holes are lined up, and the bolts 220 are inserted therethrough to fasten together the plates 210a,b and the vertical portion 215 of the L-bracket 212 or other mounting surface. As is more clearly shown in FIG. 4, the through-holes 225 in the plates 210a,b are preferably vertically elongated. Thus, the height of the plates 210a,b can be adjusted by sliding the plates 210a,b up or down in a vertical direction and tightening the bolts 220 at the desired location. This allows the fish loading device 150 to be adjusted for varying sizes of fish and varying table top 20 heights.

FIG. 4 is a side view of the fish loading device 150 and more clearly illustrates one embodiment of one of the plates 210a that comprise the device 150. The plates 210a,b are preferably shaped to accept a headed and gutted fish, and to hold the fish in the proper position until the transport saddle 130 moves between the plates 210a,b and picks up the fish, carrying it through the various processing stations. Each of the plates 210a,b is of a generally rectangular shape, with a front portion 275 of the plate being generally tapered. Thus, the top edge 276 of the plate 210a slopes gradually downward from the back end 277 to the front 275. Each plate 210a has a bottom edge 272 that is substantially parallel to the horizontal plane and to the path of the transport saddle 130. Preferably, as shown in the embodiment illustrated in FIG. 4, the top edge 276 terminates at least slightly forward of the front edge 278 of the plate 210a.

In the embodiment illustrated in FIG. 4, the front top corner 280 of the plate 210a at which the front edge 278 and the top edge 276 intersect is rounded such that the rounded portion extends forward and above the front end of the bottom edge 272. This configuration keeps the fish from sliding forward off the device 150 and also allows the fish-loading device 150 to hold the fish in position and release it without the risk of snagging the flesh of the fish when the transport saddle 130 engages the fish.

Preferably, the height of the plates 210a,b is adjusted after the height of the table top is set. The plates 210a, b are preferably set so that the front end of the top edge 280 is approximately 2 mm above the front spike of the transport saddle 130.

In a preferred embodiment, the plates 210a,b are relatively flat. However, the plates 210a,b can be made either concave or convex. Additionally, the plates 210a,b need not be a continuous surface.

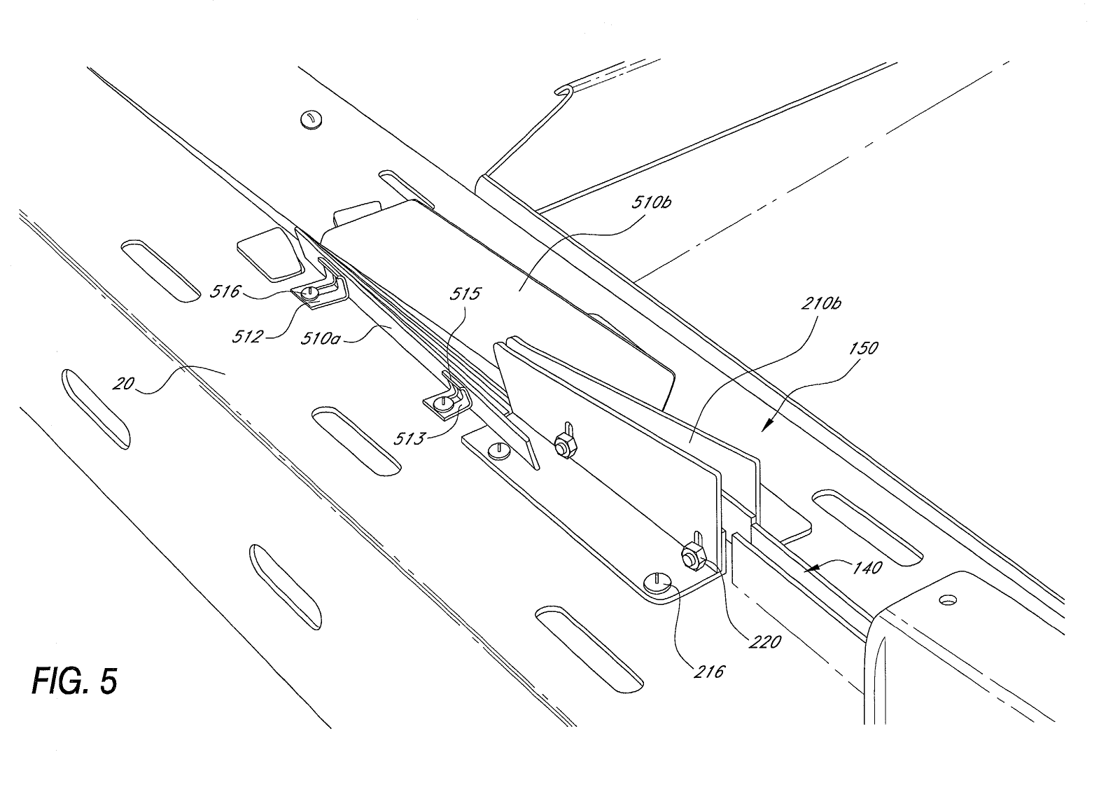

FIGS. 5-7 illustrate a further embodiment of the fish loading device 150 according to the present invention. As illustrated in FIG. 5, in addition to the plates 210a,b described above, this embodiment of the fish loading device 150 is provided with two guide elements 510a,b positioned on either side of the transport track 140. The two guide elements 510a,b extend vertically from the surface of the table top 20, and are inclined outward, preferably at an angle of approximately 50 degrees, with respect to the vertical plane extending through the transport track 140. The guide elements 510a,b are located downstream (in the direction of movement of the transport saddle 130) of the two support plates 210a,b. The two guide elements 510a,b are spaced apart such that at least a section of the support plates 210a,b is positioned between the two guide elements 510a,b, and to allow the transport saddle to pass between the guide elements 510a,b. The guide elements 510a,b are preferably substantially flat plates, made of metal such as stainless steel or aluminum.

The guide elements 510a,b are preferably mounted directly onto the table top 20. FIGS. 5-7 illustrate the use of L-brackets 512 to mount the guide elements 510a,b onto the fish processing machine. The mounting is preferably removable and adjustable, although it can be permanent if desired. The L-bracket 512 has a horizontal portion 513 and a vertical portion 515. Screws 516 are preferably used to secure the horizontal portion 513 of the L-bracket 512 to the table top 20, although other removable fastening means can also be used. The vertical portion 515 of the L-bracket 512 is secured to the guide elements 510a,b using bolts, screws or similar removable fasteners. Alternatively, the L-bracket can be permanently mounted to the table top 20, to the guide elements 510a,b, or to both.

Each of the guide elements 510a,b is also preferably provided with through-holes that match the through-holes in the vertical portion 515 of the L-bracket 512 or other mounting surface. The holes are lined up, and the fasteners are inserted therethrough to fasten together the guide elements 510a,b and the L-bracket 512 or other mounting surface.

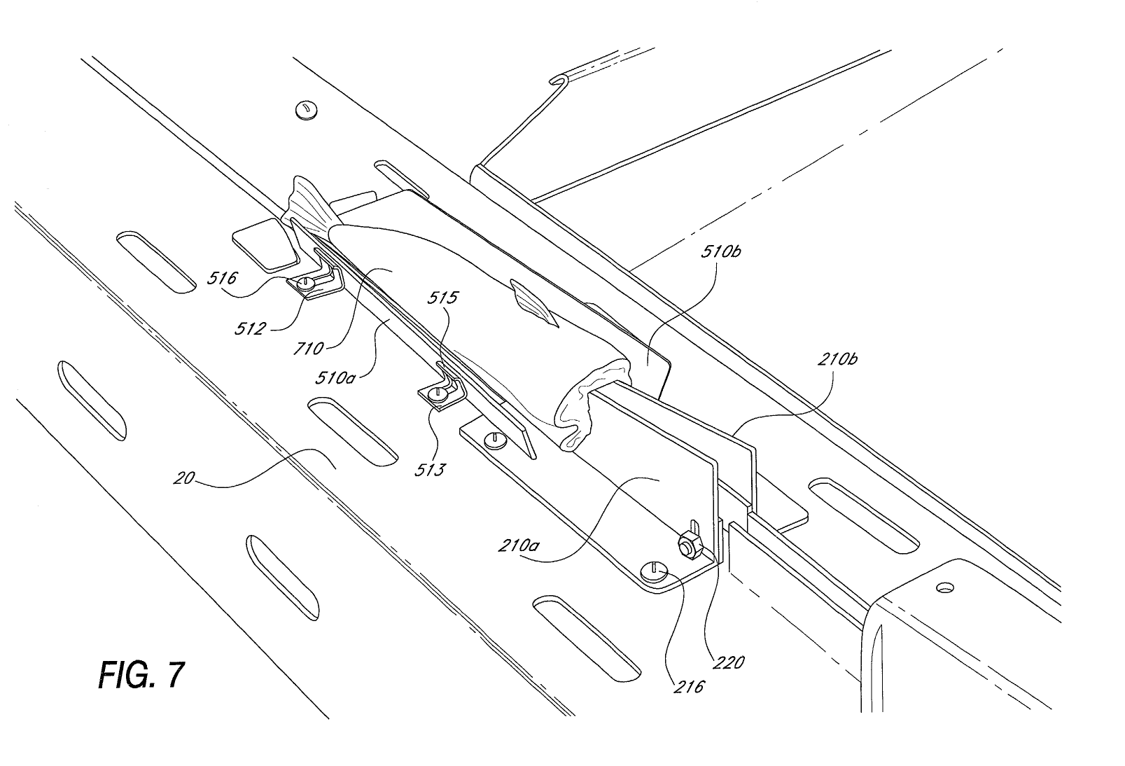

FIG. 6 illustrates the position of the support plates 210a,b and the guide elements 510a,b with respect to the transport track 140 and the transport saddle 130. As illustrated in FIG. 6, the transport saddle 130 moves from right to left along the transport track 140. FIG. 7 illustrates the positioning of a gutted and headed fish 710 on the fish loading device 150. A worker places the fish 710 onto the fish loading device 150. As the transport saddle 130 moves between the two plates 210a,b and engages the fish 710, the guide elements 510a,b act to further position and steady the fish 710 on the saddle 130. The guide elements 510a,b therefore assist in the proper placement of the fish 710 on the saddle 130.

Thus, the invention eliminates variations in the placing of the fish on the saddle by a human. The worker is able to consistently place the fish in the proper orientation on the fish loading device 150. This in turn results in each fish being placed in the same position relative to the saddle 130. As a result, the processing tools can be adjusted to be more accurate, yielding larger filets with less waste. Additionally, the worker is able to place the fish on a stationary target rather than a moving saddle, further eliminating variances in the placement of the fish. The fish body is prevented from moving to one side or falling off the saddle. The worker also no longer needs to wait for the saddle to reach his station while holding the fish. Instead, he or she can place the fish on the fish loading device at his or her own pace, and the fish is automatically and securely loaded onto the transport saddle when the saddle passes through the region.

The foregoing description details certain embodiments of the invention. It will be appreciated, however, that no matter how detailed the foregoing appears, the invention may be embodied in other specific forms without departing from its spirit or essential characteristics. The described embodiment is to be considered in all respects only as illustrative and not restrictive and the scope of the invention is, therefore, indicated by the appended claims. All changes which come within the meaning and range of equivalency of the claims are to be embraced within their scope.

What is claimed is:

1. A fish loading device for use in a fish processing machine, comprising:
a pair of substantially parallel plates mounted on either side of a transport track, said transport track being used to carry fish through said fish processing machine, said plates being spaced apart sufficiently to allow a transport saddle to pass between them, wherein said plates are adapted to hold a fish in a fixed position and allow said transport saddle to engage and remove said fish from said plates as it passes.

2. The fish loading device of claim 1, wherein said plates are formed of metal.

3. The fish loading device of claim 2, wherein said plates are formed of stainless steel.

4. The fish loading device of claim 1, wherein said plates are mounted using an L-shaped bracket.

5. The fish loading device of claim 1, wherein the plates are mounted to a support rail.

6. The fish loading device of claim 1, wherein the plates are substantially flat.

7. The fish loading device of claim 1, wherein the plates are removably mounted.

8. The fish loading device of claim 1, wherein the vertical position of the plates relative to the transport track is adjustable.

9. The fish loading device of claim 1, wherein the plates are provided with a vertically elongated through-hole to enable adjustment of the vertical height of the plates.

10. The fish loading device of claim 1, wherein each plate is substantially rectangular in shape, and has a back end that tapers toward a front end of the plate.

11. The fish loading device of claim 1, wherein each plate has a rounded front top edge which extends slightly forward of a bottom front edge, to prevent snagging of the fish as is it removed from the plate.

12. The fish loading device according to claim 1, further comprising:
a pair of guide elements located on either side of said transport track, located downstream of the plates, wherein said guide elements are angled outward, and wherein at least a portion of the plates is located between said guide elements, and said guide elements are spaced apart sufficiently to allow said transport saddle to pass between them.

13. The fish loading device of claim 12, wherein the guide elements are positioned at an angle of approximately 50 degrees.

14. The fish loading device of claim 12, wherein the guide elements are mounted on a table top that extends horizontally on either side of said transport track.

15. The fish loading device of claim 12, wherein said guide elements are substantially flat.

16. The fish loading device of claim 12, wherein the guide elements are made of metal.

17. The fish loading device of claim 12, wherein the guide elements are mounted using an L-shaped bracket.

18. The fish loading device of claim 1, wherein the guide elements are removably mounted.

19. A fish processing machine, comprising:
a loading area;
a transport track formed along a longitudinal axis, said track passing through said loading area;
a transport saddle which travels along said transport track; and
a loading device comprising a pair of substantially parallel plates mounted on either side of said transport track, said plates being spaced apart sufficiently to allow said transport saddle to pass between them, wherein said plates are adapted to hold a fish in a fixed position and allow said transport saddle to engage and remove said fish from said plates as it passes between them.

20. The fish processing machine of claim 19, further comprising a pair of guide elements located on either side of said transport track, located downstream of the plates, wherein said guide elements are angled outward, and wherein at least a portion of the plates is located between said guide elements, and said guide elements are spaced apart sufficiently to allow said transport saddle to pass between them.

21. In a fish processing machine having a transport saddle adapted for carrying the body of a fish along a transport track through various processing stations, the improvement comprising a fish loading device comprising a pair of plates positioned on either side of the transport track, spaced sufficiently apart to allow said transport saddle to pass between said plates, wherein the plates are configured to hold the body of the fish in a fixed position relative to said transport saddle, wherein said transport saddle engages and transports the fish body as it moves along the transport track.

22. A method for loading a fish onto an automated fish processing machine having at least one processing station, comprising:
placing the body of a fish onto a fish loading device, said device comprising a pair of plates mounted substantially parallel on either side of a transport track, wherein the device securely holds the body of the fish in a fixed position; and
moving a transport saddle along the transport track and between said plates to engage the body of the fish and carry it along said transport track and through the processing station.
